(19) United States
(12) Patent Application Publication
(10) Pub. No.: US 2019/0031516 A1
(43) Pub. Date: Jan. 31, 2019

(54) METHOD FOR PRODUCING SILICON

(71) Applicant: Wacker Chemie AG, Munich (DE)

(72) Inventor: Peter GIGLER, Dachau (DE)

(73) Assignee: Wacker Chemie AG, Munich (DE)

(21) Appl. No.: 16/077,502

(22) PCT Filed: Feb. 15, 2017
(86) PCT No.: PCT/EP2017/053427

§ 371 Date: Aug. 13, 2018

(30) Foreign Application Priority Data
Feb. 24, 2016 (DE) 10 2016 202 889.8

(51) Int. Cl. C01B 33/023

(52) U.S. Cl. CPC C01B 33/023; C01F 5/02

(57) ABSTRACT

Elemental silicon is produced in higher yield and with less production of byproducts when magnesium oxide having a large particle size is used as a reaction moderator.

### CROSS REFERENCE TO RELATED APPLICATIONS

This application is the U.S. National Phase of PCT Appln. No. PCT/EP2017/053427 filed Feb. 15, 2017, which claims priority to German Application No. 10 2016 202 889.8, filed Feb. 24, 2016, the disclosures of which are incorporated in their entirety by reference herein.

### BACKGROUND OF THE INVENTION

### 1. Field of the Invention

The invention relates to processes for producing silicon by magnesiothermic reduction of silicon dioxide.

### 2. Description of the Related Art

Silicon is a constituent of a very wide variety of products having great economic growth potential, in particular in the electronics sector, for example in semiconductors, lithium-ion batteries or solar cells, and the demand for silicon is therefore constantly increasing. As a result there is a constant need to further improve processes for producing silicon. One established chemical method for obtaining silicon is the reduction of silicon dioxide with magnesium (magnesiothermic reduction) as illustrated by the following reaction scheme:

SiO₂+2Mg-->2MgO+Si

A disadvantage of magnesiothermic reduction is that it forms considerable amounts of byproducts, such as magnesium silicate or magnesium silicide.

Magnesiothermic reduction was described for the first time in 1889 by Gattermann in BER. DEUT. CHEM. GES. 1889, 22, 186. The enormous reaction enthalpy ΔH of the reaction (ΔH=−293 kJ/mol) was reported even then. In order to keep the progress of the reaction controllableLEHRBUCH DER ANORGANISCHEN CHEMIE, Holleman and Wiberg (1995, 101^{st} Edition, page 877) recommends addition of magnesium oxide as a moderator. To this end, WO 2008/067391 A2 recommends cooling the reactor or adding inert materials, for example metal (oxides) or metal salts of for example chlorides, sulfides or nitrates. Recited examples of inert materials are sodium chloride or alternatively magnesium oxide which are employed for example in a proportion of 72% by weight (MgO, Riedel-de-Haen #13138, BET: 42 m²/g) or 65% by weight (NaCl) based on the starting mixture. WO 2011/042742 A1 recommends sodium chloride or alternatively calcium chloride as moderators for the reduction of SiO₂ with magnesium.

However there is also a multiplicity of known processes for magnesiothermic reduction which operate without moderator addition. For example U.S. Pat. No. 7,615,206 B2 describes the structure-retaining magnesiothermic reduction of nano- to microscale silica starting structures, such as diatomaceous earth. “Nature 2007 446, 172” also teaches a structure-retaining route to defined silicon structures by reduction of SiO₂ with magnesium. Further non-moderated variants of magnesiothermic reduction are described in WO 10139346 A1, WO 2013179068 A2, KR 100493960, TWI 287890B and WO 2013147958 A2. U.S. Pat. No. 8,268,481 BB describes processes for producing silicon by reduction of pyrogenic silica with metallic reducing agents, for example magnesium or aluminum. The addition of fluxes or solvents is recommended for activating the metallic reducing agents and the use of high thermal conductivity metals, such as copper or brass, is recommended for controlling the reaction temperature.

Against this background there remained a challenge in the magnesiothermic reduction of SiO₂ to control the great and instantaneously liberated heat of reaction. This represents a grave problem in particular when performing the reaction on an industrial scale. A further objective is to reduce the amount of byproducts in the magnesiothermic reduction, such as magnesium silicate or magnesium silicide, and to increase the yield of silicon.

It is accordingly an object of the invention to modify the magnesiothermic reduction of silicon dioxide such that the reaction temperature is controlled while simultaneously the formation of byproducts, in particular of magnesium silicate, is reduced and the silicon yield is increased.

### SUMMARY OF THE INVENTION

These and other objects have been surprisingly achieved when the reactants of the magnesiothermic reduction were admixed with magnesium oxide having a BET surface area of ≤40 m²/g as moderator. This was all the more surprising since the conventional addition of magnesium oxide increases the formation of the undesired byproduct magnesium silicate and thus reduces the Si yield.

### DETAILED DESCRIPTION OF THE PREFERRED EMBODIMENTS

The present invention provides thus processes for producing silicon by magnesiothermic reduction of silicon dioxide, characterized in that to achieve magnesiothermic reduction a mixture (reactant mixture) comprising silicon dioxide (SiO₂), magnesium (Mg) and, as a moderator, magnesium oxide (MgO) having a BET surface area of ≤40 m²/g is employed.

The silicon dioxide may be in amorphous or crystalline form. It may be of synthetic or natural origin. Examples of silicon dioxide are pyrogenic silica, precipitated silica, quartz, tridymite, christobalite, diatomaceous earth or in the form of silicate-bound SiO₂, such as forsterite or enstatite. Synthetic amorphous silicas are preferred, pyrogenic silica is particularly preferred.

The volume-weighted particle size distribution D₅₀ of the SiO₂ particles is for example 10 nm to 500 μm, preferably 100 nm to 100 μm and most preferably 500 nm to 50 μm (method of determination: static light scattering, Horiba LA 950 instrument, dispersion medium water).

The specific surface area (BET) of the SiO₂ is for example 1 to 500 m²/g, preferably 10 to 300 m²/g and more preferably 15 to 200 m²/g (determined according to DIN 66131 (with nitrogen), for example with a Porotec Sorptomatic 1990 instrument).

Magnesium may be employed for example in the form of wire, preferably in the form of turnings and more preferably in the form of powder. The particle size of the magnesium is for example 1 μm to 10 mm, preferably 5 μm to 5 mm and more preferably 10 μm to 500 μm.

The stoichiometric ratio of silicon dioxide to magnesium (SiO₂/Mg) in the reactant mixture is preferably 0.3 to 1, more preferably 0.4 to 0.7 and most preferably 0.4 to 0.6.

The magnesium oxide present in the reactant mixture is also referred to as the moderator herein.

The magnesium oxide employed as a moderator may be of natural or synthetic origin.

The volume-weighted particle size distribution D₅₀ of the MgO particles is for example 1 μm to 1 mm, preferably 5 μm to 500 μm and more preferably 10 μm to 200 μm.

The specific surface area (BET surface area) of the magnesium oxide is ≤40 m²/g, preferably 35 m²/g, more preferably ≤30 m²/g, yet more preferably ≤25 m²/g and most preferably ≤20 m²/g. The BET surface area of the magnesium oxide is preferably ≥0.01 m²/g. The determination of the BET surface area is carried out according to DIN 66131 (with nitrogen), for example with a Porotec Sorptomatic 1990 instrument.

The bulk density of the magnesium oxide is preferably 0.05 to 3 g/cm³, more preferably 0.08 to 2.5 g/cm³ and most preferably 0.1 to 2 g/cm³ (determination according to DIN ISO 697).

The magnesium oxide preferably has a purity of ≥85% by weight, more preferably ≥90% by weight, most preferably ≥95% by weight. Purity is determined by ICP (inductively coupled plasma) emission spectrometry (Perkin Elmer Optima 7300 DV). The magnesium oxide is subjected to acidic digestion therefor. The ICP determination is based on “ISO 11885 Wasserbeschaffenheit—Bestimmung von ausgewahlten Elementen durch induktiv gekoppelte Plasma-Atom-Emissionsspektrometrie (ICP-OES) (ISO 11885:2007); German version EN ISO 11885:2009”.

Further moderators may optionally be employed in addition to magnesium oxide. Examples of further moderators are alkali metal or alkaline earth metal halides, such as sodium chloride or calcium chloride, or magnesium oxide having a noninventive BET surface area.

The reactant mixture preferably contains ≥60% by weight, more preferably ≥80% by weight and most preferably ≥90% by weight of magnesium oxide based on the total weight of the moderators. Possible further moderators are present in the reactant mixture for example to an extent of ≤40% by weight, preferably ≤20% by weight and more preferably ≤10% by weight based on the total weight of the moderators. It is most preferable when no further moderators are employed in addition to magnesium oxide.

Here, silicon dioxide and magnesium are also referred to collectively as reactants.

The weight ratio of the reactants to the moderator is preferably 0.05 to 1, more preferably 0.2 to 0.7 and most preferably 0.3 to 0.6.

The reactant mixture may contain further optional constituents, for example dopants such as diboron trioxide. In the course of the magnesiothermic reduction, diboron trioxide for example may be reduced to elemental boron and may serve the resulting silicon as a dopant. The proportion of the optional constituents is for example up to 5% by weight, preferably 1 ppb (parts per billion) to 5% by weight, based on the total weight of the reactant mixtures.

To produce the reactant mixture the constituents thereof may be mixed in a sequence which is discretionary per se. The silicon dioxide and the magnesium may be employed separately or preferably in the form of a mixture. The moderator may be added to a mixture of silicon dioxide and magnesium or preferably mixed together with silicon dioxide and magnesium.

Silicon dioxide, magnesium and the magnesium oxide used as the moderator are thus generally mixed before performance of the magnesiothermic reduction, i.e. generally mixed before introduction into the reactor.

The mixing is preferably carried out at ambient temperature, for example at room temperature, more preferably at 15° C. to 35° C. In any case, the mixing is carried out at temperatures of preferably <400° C., more preferably ≤390° C. and most preferably ≤350° C.

To mix the constituents of the reactant mixture the mixers commonly used therefor, in particular industrial mixers, may be used. Examples of mixers are freefall mixers, such as container mixers, cone mixers, drum roller mixers, gyro mixers, tumble mixers or displacement and impeller mixers such as drum mixers and screw mixers. Further examples of suitable mixers are set out in “Mischen von Feststoffen” by R. Weinekötter and H. Gericke, Springer 1995.

The magnesiothermic reduction may be performed in reactors commonly used therefor, in particular furnaces, for example tube furnaces, rotary tube furnaces, chamber furnaces, belt furnaces or moving-grate furnaces. The reactors may be operated discontinuously or continuously. The reactors may optionally be cooled by conventional means. However, the reactor is generally not cooled.

The reactant mixtures may be introduced into the reactors for example in the form of pellets, granules or preferably in the form of powder beds.

The magnesiothermic reduction is preferably carried out at 400° C. to 1200° C., more preferably at 500° C. to 1100° C. and most preferably at 600° C. to 1050° C.

The magnesiothermic reduction is generally initiated thermally, i.e. by heating the reactant mixture to a temperature within the abovementioned temperature range.

The pressure in the reactor is preferably 0.5 to 10 bar_{abs.}, more preferably between 0.7 to 5 bar_{abs.} and most preferably between 0.8 to 1.5 bar_{abs.}.

The magnesiothermic reduction is preferably performed under a protective gas atmosphere, in particular under an argon atmosphere or an argon/hydrogen atmosphere, in particular one having a hydrogen proportion of ≤5 vol %.

The residence time of the mixture in the reactor is preferably 1 second to 12 hours, more preferably 1 second to 6 hours and most preferably 1 second to 3 hours.

The mixture leaving the reactor (product mixture) generally contains silicon, magnesium oxide and optionally one or more further constituents, such as magnesium silicate, magnesium silicide, and optionally boron. Furthermore, unconverted reactants may also be present, such as magnesium, silicon dioxide or possibly diboron trioxide.

The product mixture contains preferably 1% to 40% by weight, more preferably 2% to 35% by weight and most preferably 5% to 30% by weight of silicon, preferably 45% to 99% by weight, more preferably 50% to 96% by weight and most preferably 55% to 94% by weight of magnesium oxide, preferably 0% to 40% by weight, more preferably 0% to 30% by weight and most preferably 0% to 20% by weight of further constituents, wherein the reported % by weight values are each based on the total weight of the product mixture and for each product mixture total 100% by weight.

The workup of product mixtures may be carried out for example by addition of one or more acids. Examples of acids are hydrohalic acids, such as hydrochloric acid or hydrofluoric acid, carboxylic acids, such as acetic acid, or oxoacids of phosphorus, such as phosphoric acid. Preference is given to acetic acid or hydrochloric acid. When two or more acids are employed these may be employed as a mixture or preferably consecutively. Workup may thus also be carried out in two stages with different acids, for example by a first acid treatment with hydrochloric acid and a second treatment with hydrofluoric acid.

The acids are preferably employed in the form of aqueous solutions. The concentration of the employed acids is preferably 0.01 to 10 mol/L, more preferably 0.1 to 8 mol/L, and most preferably 1 to 5 mol/L.

The molar ratio of the protons of the acids to the magnesium oxide of the product mixture to be worked up is preferably at least 2 to 1.

The thus obtained silicon may finally be dried, for example at temperatures of 0° C. to 200° C., preferably at 20° C. to 150° C. and most preferably at 40° C. to 100° C. The pressure during drying is by preference 0.01 to 1 bar_{abs.} and more preferably, 0.1 to 0.5 bar_{abs.}.

The thus obtained product preferably contains 50 to 100 wt %, more preferably 60 to 100 wt % and most preferably 70 to 100 wt % of silicon based on the total weight of the product.

The silicon produced in accordance with the invention may be used as a raw material for all common applications for silicon, for example in electronic applications. Particular examples are semiconductors, solar cells, thermoelectric generators and in particular as an active material for lithium-ion batteries.

Use of magnesium oxide according to the invention as a moderator in magnesiothermic reduction makes it possible to exercise control over the heat of reaction thereof and thus over the process—even when performing the process on an industrial scale. Surprisingly, the use of magnesium oxide having a BET surface area according to the invention results in higher silicon yields. Fortunately, the formation of the byproduct magnesium silicate was suppressed and the conversion of the reactants increased.

Another advantage is that the magnesium oxide employed as a moderator is chemically identical to the byproduct of the magnesiothermic reduction so that the moderator can be removed together with the magnesium oxide formed during the reaction without a separate washing step being required for removal of the moderator.

The examples which follow serve to further elucidate the invention:

In the examples which follow, all amounts and percentages are by weight, all pressures are 0.10 MPa (abs.) and all temperatures are 20° C. unless otherwise stated. The reported elemental contents (Mg, Si) were determined by ICP (inductively coupled plasma) emission spectrometry (Perkin Elmer Optima 7300 DV instrument). The oxygen content was calculated from the difference from 100%.

The product compositions were calculated starting from the elemental contents (Si, O, Mg) under the boundary condition, demonstratably satisfied via XRD, that magnesium oxide was fully removed in the aqueous workup and the isolated product was composed of Si(0), Mg₂SiO₄ and SiO₂. The Mg content of the isolated product was used to calculate the magnesium silicate content and subsequently the SiO₂ and Si(0) contents of the isolated product. The proportion of MgO present before the aqueous workup was determined from the dissolved amount of magnesium in the filtrate of the washing solution.

### Comparative Example 1

Mg-thermic reduction using MgO having a BET surface area of 102 m²/g as moderator:

1.16 g of silicon dioxide (WACKER HDK® V15) and 0.94 g of magnesium powder (Alfa Aesar, 325 mesh, 99.8%) were blended with 4.88 g of magnesium oxide (Sigma-Aldrich, item no. 342793, ≥99%, 325 mesh) having a surface area of 102 m²/g (measured according to DIN 66131 in a Porotec Sorptomatic 1990 instrument) with a pestle and mortar and subsequently heated to 1000° C. for 2 h (heating rate 10° C./min) in a steel boat in an argon-inertized tube furnace and then cooled.

6.51 g of the obtained product mixture having a composition of 4.7% by weight Si(0), 87.2% by weight MgO, 6.3% by weight Mg₂SiO₄, 1.8% by weight SiO₂ were added with ice-bath cooling to 136 g of acetic acid (20% by weight in water) and the mixture was stirred for 3 h. The obtained suspension was filtered, washed with water (paper filter of pore size 4-7 μm; 5.60 g MgO dissolved in filtrate) and the residue was dried at 55° C. (2 mbar abs.) for 20 h. 0.82 g of product of elemental composition 53% by weight Si, 17% by weight Mg and 30% by weight 0 was obtained. This corresponds to 36.5% by weight Si(0), 49.2% by weight Mg₂SiO₄, 14.3% by weight SiO₂ and thus to a molar yield of Si(0) of 59% based on the amount of silicon employed in the form of SiO₂.

### Comparative Example 2

Mg-thermic reduction using MgO having a BET surface area of 42 m²/g as moderator according to WO 2008/067391 A2:

1.33 g of silicon dioxide (WACKER HDK® V15) and 1.07 g of magnesium powder (Alfa Aesar, 325 mesh, 99.8%) were blended with 5.61 g of magnesium oxide (Sigma-Aldrich, item no. 13138, puriss.) having a surface area of 42 m²/g (measured according to DIN 66131 in a Porotec Sorptomatic 1990 instrument) with a pestle and mortar and subsequently heated to 1000° C. for 2 h (heating rate 10° C./min) in a steel boat in an argon-inertized tube furnace and then cooled.

7.32 g of the obtained product mixture having a composition of 5.1% by weight Si(0), 91.0% by weight MgO, 1.3% by weight Mg₂SiO₄, 2.6% by weight SiO₂ were added with ice-bath cooling to 151 g of acetic acid (20% by weight in water) and the mixture was stirred for 3 h. The obtained suspension was filtered, washed with water (paper filter of pore size 4-7 μm; 6.24 g MgO dissolved in filtrate) and the residue was dried at 55° C. (2 mbar abs.) for 20 h. 0.62 g of product of elemental composition 73% by weight Si, 5% by weight Mg and 22% by weight 0 was obtained. This corresponds to 56.6% by weight Si(0), 14.5% by weight Mg₂SiO₄, 28.9% by weight SiO₂ and thus to a molar yield of Si(0) of 62% based on the amount of silicon employed in the form of SiO₂.

### Example 3

Mg-thermic reduction using MgO having a BET surface area of 25 m²/g as moderator:

1.00 g of silicon dioxide (WACKER HDK® V15) and 0.81 g of magnesium powder (Alfa Aesar, 325 mesh, 99.8%) were blended with 4.21 g of magnesium oxide (Sigma-Aldrich, item no. 63090, puriss. p.a.) having a surface area of 25 m²/g (measured according to DIN 66131 in a Porotec Sorptomatic 1990 instrument) with a pestle and mortar and subsequently heated to 1000° C. for 2 h (heating rate 10° C./min) in a steel boat in an argon-inertized tube furnace and then cooled.

5.90 g of the obtained product mixture having a composition of 6.3% by weight Si(0), 91.5% by weight MgO, 2.0% by weight Mg₂SiO₄, 0.2% by weight SiO₂ were added with ice-bath cooling to 123 g of acetic acid (20% by weight in water) and the mixture was stirred for 3 h. The obtained suspension was filtered, washed with water (paper filter of pore size 4-7 μm; 5.47 g MgO dissolved in filtrate) and the residue was dried at 55° C. (2 mbar abs.) for 20 h. 0.51 g of product of elemental composition 80% by weight Si, 8% by weight Mg and 12% by weight 0 was obtained. This corresponds to 74.1% by weight Si(0), 23.2% by weight Mg₂SiO₄, 2.8% by weight SiO₂ and thus to a molar yield of Si(0) of 82% based on the amount of silicon employed in the form of SiO₂.

### Example 4

Mg-thermic reduction using MgO having a BET surface area of 8 m²/g as moderator:

1.33 g of silicon dioxide (WACKER HDK® V15) and 1.08 g of magnesium powder (Alfa Aesar, 325 mesh, 99.8%) were blended with 5.60 g of magnesium oxide (Sigma-Aldrich, item no. 63093, purum p.a.) having a surface area of 8 m²/g (measured according to DIN 66131 in a Porotec Sorptomatic 1990 instrument) with a pestle and mortar and subsequently heated to 1000° C. for 2 h (heating rate 10° C./min) in a steel boat in an argon-inertized tube furnace and then cooled.

7.89 g of the obtained product mixture having a composition of 6.3% by weight Si(0), 92.1% by weight MgO, 0.7% by weight Mg₂SiO₄, 0.9% by weight SiO₂ were added with ice-bath cooling to 165 g of acetic acid (20% by weight in water) and the mixture was stirred for 3 h. The obtained suspension was filtered, washed with water (paper filter of pore size 4-7 μm; 7.21 g MgO dissolved in filtrate) and the residue was dried at 55° C. (2 mbar abs.) for 20 h. 0.62 g of product of elemental composition 87% by weight Si, 3% by weight Mg and 10% by weight 0 was obtained. This corresponds to 80.0% by weight Si(0), 8.7% by weight Mg₂SiO₄, 11.4% by weight SiO₂ and thus to a molar yield of Si(0) of 81% based on the amount of silicon employed in the form of SiO₂.

TABLE 1

| | | Yield | | |
|---|---|---|---|---|
| | | Si (0) | | |
| | BET | [% by | Byproducts | Si (0) |
| | [m²/g] | weight] | [% by weight] | (molar) |
| Comparative example 1 | 102 | 36 | 64 | 59% |
| Comparative example 2 | 42 | 57 | 43 | 62% |
| Example 3 | 25 | 74 | 26 | 82% |
| Example 4 | 8 | 80 | 20 | 81% |

By using magnesium oxide according to the invention as moderator (examples 3 and 4) significantly higher yields of elemental Si(0) based on silicon employed in the form of SiO₂ were obtained and the proportion of byproduct was markedly reduced.

1.-8. (canceled)

9. A process for producing silicon by magnesiothermic reduction of silicon dioxide, comprising:
magnesiothermically reducing a reactant mixture comprising silicon dioxide, magnesium, and, as a moderator, magnesium oxide having a BET surface area of ≤40 m²/g.

10. The process for producing silicon of claim 9, wherein the magnesium oxide employed as the moderator has a BET surface area of ≤35 m²/g.

11. The process for producing silicon of claim 9, wherein the weight ratio of silicon dioxide and magnesium to the moderator magnesium oxide is 0.05 to 1.

12. The process for producing silicon of claim 9, wherein in addition to magnesium oxide, the reactant mixture optionally contains one or more further moderators, wherein the proportion of magnesium oxide is ≥60% by weight based on the total weight of the moderators.

13. The process for producing silicon of claim 9, wherein no further moderators are employed in addition to magnesium oxide.

14. The process for producing silicon of claim 9, wherein silicon dioxide, magnesium and magnesium oxide moderator are mixed before introduction into the reactor for performing the magnesiothermic reduction.

15. The process for producing silicon of claim 9, wherein the product mixture contains 1% to 40% by weight of silicon, 45% to 99% by weight of magnesium oxide and 0% to 40% by weight of further constituents, wherein the reported % by weight values are based on the total weight of the product mixture and for each product mixture sum to 100% by weight.

16. The process for producing silicon of claim 9, wherein the product mixture is worked up by adding one or more acids and the thus obtained product contains 50% to 100% by weight of silicon based on the total weight of the product.
